(19) United States
(12) Patent Application Publication
(10) Pub. No.: US 2025/0115022 A1
(43) Pub. Date: Apr. 10, 2025

(54) MULTI-FUNCTIONAL, MULTI-LAYERED HYBRID COMPOSITE STRUCTURE

(71) Applicants: GM GLOBAL TECHNOLOGY OPERATIONS LLC, Detroit, MI (US); SEKISUI Aerospace, Inc., Sumner, WA (US)

(72) Inventors: Mary GILLIAM, Farmington Hills, MI (US); David A. Okonski, Waterford, MI (US); Selina Xinyue Zhao, Rochester Hills, MI (US); Blair E. Carlson, Ann Arbor, MI (US); Scott James, Buckley, WA (US); Daniel Miranda, Seattle, WA (US)

(21) Appl. No.: 18/483,631

(22) Filed: Oct. 10, 2023

(51) Int. Cl. B32B 5/02; B32B 7/12; B32B 9/00; B32B 9/04; B32B 19/06; H01M 50/227; H01M 50/229; H01M 50/231; H01M 50/24

(52) U.S. Cl. CPC B32B 5/02; B32B 7/12; B32B 9/005; B32B 9/047; B32B 19/06; H01M 50/227; H01M 50/229; H01M 50/231; H01M 50/24; B32B 2260/021; B32B 2260/046; B32B 2307/212; B32B 2307/3065; B32B 2457/10; B32B 2571/00

(57) ABSTRACT

A multi-layer and multi-functional composite structure includes a structural reinforcing portion configured to provide structural support. The structural reinforcing portion includes reinforcing fibers consolidated in a thermoplastic resin. A protecting portion is arranged on one side of the structural reinforcing portion and configured to provide at least one of thermal blocking and fire resistance. A shielding portion is arranged on an opposite side of the structural reinforcing portion and configured to shield electromagnetic interference (EMI).

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to multi-functional and multi-layered hybrid composite structures.

Vehicles include structural components such as enclosures or other structures that are typically made of metal such as steel or aluminum. In addition to providing structural support functions, the structural components may also need to perform other functions such as thermal insulation, fire resistance, and/or electromagnetic shielding. For example, the structural components may be used when manufacturing an enclosure for a battery pack or electric machine. When the structural components are made using aluminum or steel, the structural components may be relatively heavy.

### SUMMARY

A multi-layer and multi-functional composite structure includes a structural reinforcing portion configured to provide structural support. The structural reinforcing portion includes reinforcing fibers consolidated in a thermoplastic resin. The thermoplastic resin can be pre-impregnated into the reinforcing fibers and/or supplied during compression molding. A protecting portion is arranged on one side of the structural reinforcing portion and configured to provide at least one of thermal blocking and fire resistance. A shielding portion is arranged on an opposite side of the structural reinforcing portion and configured to shield electromagnetic interference (EMI).

In other features, the structural reinforcing portion and at least one of the protecting portion and the shielding portion are consolidated in the thermoplastic resin in a single step. The structural reinforcing portion, the protecting portion, and the shielding portion are consolidated in the thermoplastic resin in a single step. The protecting portion includes an intumescent material.

In other features, the intumescent material includes an adhesive layer configured to attach the intumescent material to the structural reinforcing portion. The protecting portion includes a mica plate attached to the protecting portion using a binder. The protecting portion includes a fabric, a thermal material, and a fire resistant material. The protecting portion includes a ceramic layer.

In other features, at least one of the protecting portion and the shielding portion comprises a coating. The shielding portion is selected from a group consisting of a metal mesh, a discontinuous fabric, a coated veil, a metal sheet, a perforated metal sheet, and a metal-coated fiber-filled material. The structural reinforcing portion comprises discontinuous fibers selected from a group consisting of chopped fibers, unidirectional tape, nonwoven mat, and directed long fibers. The thermoplastic resin is selected from a group consisting of polyether ether ketone, polyether ketone ketone, polyphenylene sulfide, and polyether imide.

In other features, planar portions of the structural reinforcing portion comprise continuous fibers and non-planar portions of the structural reinforcing portion comprise discontinuous fibers.

A multi-layer and multi-functional composite structure includes a structural reinforcing portion configured to provide structural support and including reinforcing fibers consolidated in a thermoplastic resin. A protecting portion is arranged on one side of the structural reinforcing portion and configured to provide at least one of thermal blocking and fire resistance. A shielding portion is arranged on an opposite side of the structural reinforcing portion and configured to shield electromagnetic interference (EMI). The structural reinforcing portion and at least one of the protecting portion and the shielding portion are consolidated in the thermoplastic resin in a single step.

In other features, the structural reinforcing portion, the protecting portion, and the shielding portion are consolidated in the thermoplastic resin in a single step. The protecting portion is selected from a group consisting of an intumescent material one of consolidated in the thermoplastic resin and attached to the structural reinforcing portion, a mica plate attached to the protecting portion using a binder, a ceramic layer, and a coating layer. The protecting portion includes a fabric, a thermal material, and a fire resistant material. The shielding portion is selected from a group consisting of a metal mesh, a discontinuous fabric, a coated veil, a metal sheet, and a metal-coated fiber-filled material.

In other features, the structural reinforcing portion comprises discontinuous fibers selected from a group consisting of chopped fibers, unidirectional tape, nonwoven mat, and directed long fibers. The thermoplastic resin is selected from a group consisting of polyether ether ketone, polyether ketone ketone, polyphenylene sulfide, and polyether imide. Planar portions of the structural reinforcing portion comprise continuous fibers and non-planar portions of the structural reinforcing portion comprise discontinuous fibers.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a functional block diagram of an example of a battery cell including anode electrodes, cathode electrodes, and separators;

FIG. 1B is a functional block diagram of an example of a battery pack enclosure made of a multi-functional and multi-layered thermal composite structure according to the present disclosure;

FIG. 1C is a functional block diagram of an example of an electric machine arranged in an enclosure made of a multi-functional and multi-layered thermal composite structure according to the present disclosure;

FIGS. 2A to 2C are cross-sectional views of examples of multi-functional and multi-layered thermal composite structures according to the present disclosure; and

FIGS. 3 to 5 are flowcharts of examples of methods for manufacturing the multi-layered and multi-functional hybrid composite structures according to the present disclosure.

In the drawings, reference numbers may be reused to identify similar and/or identical elements.

### DETAILED DESCRIPTION

While a multi-layered and multi-functional hybrid composite structure is described below in the context of a structural component or enclosure for a vehicle, the multi-layered and multi-functional hybrid composite structures can be used in other applications.

The present disclosure relates to a multi-layered and multi-functional hybrid composite structure (“the hybrid composite structure”) that provides high strength, reduced heat transfer, and/or electromagnetic interference (EMI) shielding. For example, the hybrid composite structure can be used to make an enclosure for a battery pack, an electric machine, or other device to reduce heat transfer and/or EMI to/from the surrounding environment. For example, the hybrid composite structure can be used to prevent thermal runaway propagation (TRP) from one battery cell, module, and/or pack to adjacent battery cells, modules, and/or packs. Enclosures or other structures made using the hybrid composite structure have reduced parts and lower mass (e.g., mass reduction of 40% or greater as compared to enclosures or other structures made of metal).

The hybrid composite structure includes multiple portions or layers supporting different functions and/or incorporating various materials such as an EMI shielding material, thermal barrier materials, flame resistant materials, reinforcing fibers, and/or resin. In some examples, the hybrid composite structure is consolidated in a single process step, such as compression molding using a thermoplastic resin. In other examples, the hybrid composite structure is consolidated in one or more process steps.

In some examples, surface pre-treatment methods can be applied to enhance adhesion between the functional layers such as the EMI shielding layer, thermal insulation layer, and/or fire resistant layer and other layers of the hybrid composite structure. Examples of surface pre-treatment include exposing the material or an adjacent surface to plasma or a flame to heat the surface to improve adhesion to adjacent layers of the hybrid composite structure.

In some examples, an inner portion of the hybrid composite structure includes a thermal insulation layer and/or a flame barrier layer embedded in resin. A middle portion of the hybrid composite structure includes reinforcing fibers embedded in resin. An outer portion of the hybrid composite structure includes an EMI shielding layer embedded in resin. The outer portion faces an outside environment. In some examples, the hybrid composite structure is made using thermoplastic resin. Thermoplastic resin has a greater potential for reclaiming and recycling as compared to thermoset resins.

The hybrid composite structure is multi-functional in that it provides strength and stiffness, TRP protection, and/or EMI shielding. In some examples, the reinforcing fibers include discontinuous fibers, continuous fibers, and/or a combination thereof in different areas of the hybrid composite structure to tailor strength and stiffness where needed.

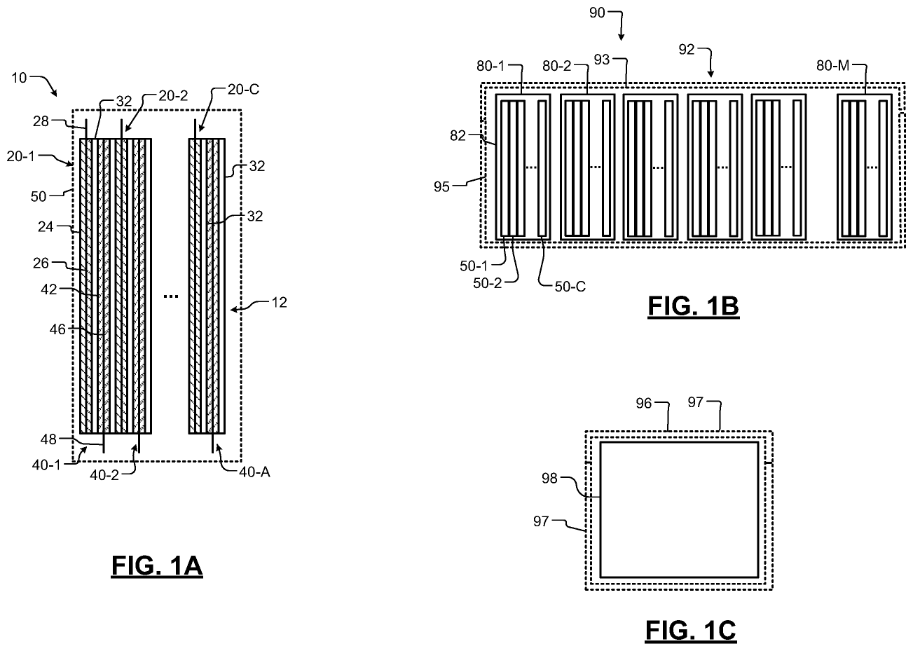

Referring now to FIGS. 1A to 1C, various examples of enclosures incorporating the hybrid composite structure are shown. In FIG. 1A, an example of a battery cell is shown. In FIG. 1B, an enclosure for a battery pack incorporating the hybrid composite structure includes a plurality of battery modules (each including an enclosure and a plurality of battery cells of FIG. 1A). In FIG. 1C, an electric machine is arranged in an enclosure incorporating the hybrid composite structure. The enclosures for the battery module, the battery pack, and/or the electric machine may include a body and/or a cover that provide a hermetic seal. The body and/or the cover can be made using the hybrid composite structures described further below.

For example, when battery cells in one or more of the battery modules or the battery pack fail, a thermal runaway event may occur. Thermal runaway events are caused when the temperature of the battery cells, battery module, and/or battery pack increases. The increased temperature releases energy from the battery cells that further increases the temperature of the battery and/or adjacent structures. If not extinguished, the battery cells, battery module, and/or battery pack undergo the thermal runaway event that may cause the temperature of other adjacent battery modules/packs to increase. The increased temperature increases the likelihood of further thermal runaway events (thermal runaway propagation (TRP)).

Referring now to FIG. 1A, a battery cell 10 includes C cathode electrodes 20, A anode electrodes 40, and S separators 32 arranged in a predetermined sequence in a stack 12 arranged in a battery cell enclosure 50. The cathode electrodes 20-1, 20-2, . . . , and 20-C (where C is an integer greater than one) include cathode active layers 24 arranged on one or both sides of cathode current collectors 26. The anode electrodes 40-1, 40-2, . . . , and 40-A (where A is an integer greater than one) include anode active layers 42 arranged on one or both sides of the anode current collectors 46.

In some examples, the anode active layers 42 and/or the cathode active layers 24 comprise coatings including one or more active materials, one or more conductive fillers/additives, and/or one or more binder materials. In some examples, the battery cells and/or electrodes are manufactured by applying a slurry to coat the current collectors in a roll-to-roll manufacturing process. In some examples, the cathode current collectors 26 and the anode current collectors 46 comprise foil layers. In some examples, the current collectors are made of one or more materials selected from a group consisting of copper, stainless steel, brass, bronze, zinc, aluminum, and alloys thereof. External tabs 28 and 48 enable external connection to the current collectors and can be arranged on the same side, opposite sides, or different sides.

In FIG. 1B, a battery pack 90 includes a battery pack enclosure 92 enclosing a plurality of battery modules 80-1, 80-2, . . . , and 80-M, where M is an integer greater than one. The battery pack enclosure 92 includes a cover 93 and a lower body or tray 95. Each of the battery modules 80 includes a battery module enclosure 82 and a plurality of battery cell enclosures 50-1, 50-2, . . . , 50-C arranged in the battery module enclosure 82. In some examples, the battery module enclosure 82 and/or the battery pack enclosure 92 are made using the hybrid composite structure.

In FIG. 1C, an electric machine 96 is arranged in an enclosure 98. In some examples, the enclosure 98 for the electric machine 96 is made using the hybrid composite structure. In some examples, the enclosure 98 may include a lid 97 and a body 99.

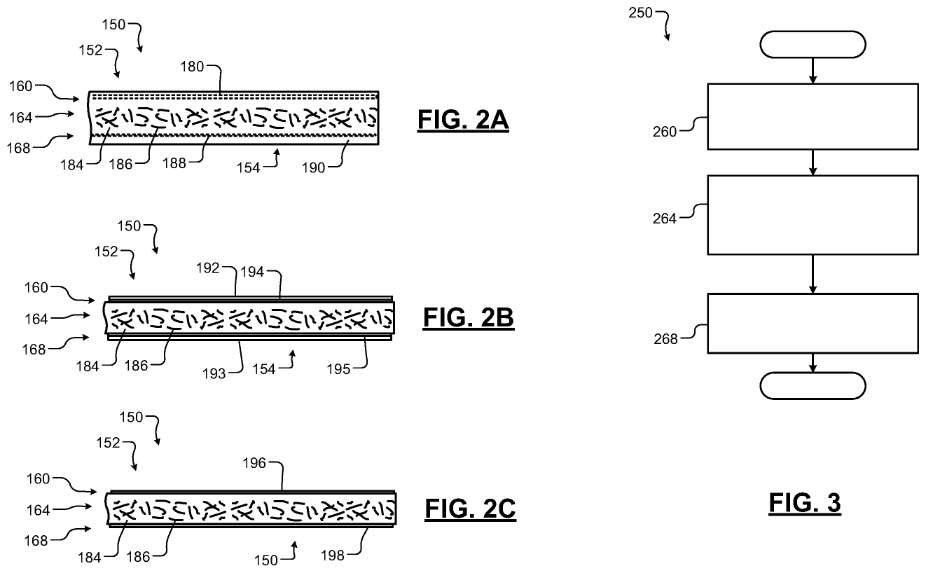

Referring now to FIGS. 2A to 2C, examples of hybrid composite structures are shown. In FIG. 2A, a multi-layered hybrid composite structure 150 includes an inner surface 152 facing the device (e.g., the battery, the electric machine, etc.) and an outer surface 154. The hybrid composite structure 150 includes a thermal protecting portion 160 configured to provide thermal blocking and/or fire resistance, a structural reinforcing portion 164 configured to provide structural support for the enclosure, and a shielding portion 168 configured to shield EMI.

In some examples the reinforcing portion 164 is consolidated and then the thermal protecting portion 160 and the shielding portion 168 are attached using adhesive and/or a surface pretreatment step such as heating using plasma or a flame. In some examples, the thermal protecting portion 160 is consolidated with the reinforcing portion 164 in the same consolidation step. In some examples, the reinforcing portion 164 is consolidated with the shielding portion 168 in the same consolidation step. In some examples, the thermal protecting portion 160, the reinforcing portion 164, and the shielding portion 168 are consolidated in the same consolidation step. In other examples, the reinforcing portion 164 is pre-consolidated and one or more additional consolidation steps are performed.

The thermal protecting portion 160 includes one or more layers 180 embedded in resin 184. The thermoplastic resin can be pre-impregnated into the reinforcing fibers and/or supplied during compression molding. In some examples, the one or more layers 180 of the thermal protecting portion 160 include an intumescent material. Examples of fire retardant materials include fabric impregnated with fire retardant such as aluminum tetrahydrate (ATH) and/or ammonium polyphosphate (APP). Additional examples of the fire retardant materials include kaolin, sodium silicate, aluminum hydroxide, magnesium hydroxide, hydrated silica, silicone, titanium dioxide, as well as compounds based on phosphorus, nitrogen, antimony, boron, zinc, or halogens such as bromine and chlorine. A combination of these materials may also be used. In some examples, the protecting portion 160 comprises a ceramic material that is embedded in the resin. In some examples, the protecting portion 160 comprises a rigid plate made of mica.

An example of the intumescent material includes expanding graphite (EG). Additional examples of the intumescent material a combination of materials to create an insulating char, including an acid source, a carbon source, and blowing agent. Acid sources help to initiate the intumescent reaction and can include phosphates that release phosphoric acid when heated, such as ammonium polyphosphate, melamine phosphate, and guanylurea phosphate, which could also act as a carbon source. Compounds that release other acids, such as boric acid, and acidic polymers can also serve as acid sources. Carbon sources provide a carbonaceous char layer and can include expandable graphite, a polyol, such as pentaerythritol and sorbitol, and a carbohydrate, such as starch, cellulose, and dextrin. Blowing agents release gas when heated, causing the intumescent material to form the expanded char layer and can include ammonium polyphosphate, melamine, ammonium bicarbonate, sodium bicarbonate, urea, and azodicarbonamide. When heated above a predetermined temperature, the intumescent material expands and forms a protective char that acts as a barrier to fire. In some examples, the predetermined temperature corresponds to a temperature encountered during a thermal runaway event.

In some examples, the one or more layers 180 include a flexible fabric that is reinforced with thermal material and/or a flame barrier layer. In some examples, the thermal material and/or flame barrier layer experience minimal or no expansion when exposed to high heat or flame. Examples include materials that undergo pyrolysis and form a carbonaceous char or an insulating layer. Examples include cement-based materials, clay, calcium silicate, silica, alumina, zirconia, gypsum, and ceramics.

In some examples, the thermal protecting portion 160 comprises a material that undergoes endothermic reactions to absorb heat. Examples of these materials include ammonium phosphate, hydrated compounds, such as hydrates of aluminum and magnesium, ammonium sulfate, melamine cyanurate, some phosphorous compounds, potassium carbonate. In some examples, the thermal protecting portion 160 maintains electrical insulation properties during exposure to flame. Examples of these materials include silicone-based compounds, phenolic resins, mineral-based compounds, and ceramics

In some examples, the reinforcing layer 164 includes reinforcing fibers 186. including continuous fibers, discontinuous fibers, and/or a mixture of continuous and discontinuous fibers. Suitable reinforcing fibers include carbon fibers (e.g., carbon black, carbon nanotubes, talc, fibers derived from polyacrylonitrile, cellulosic precursors, and/or pitch precursors), glass fibers (e.g., fiber glass, quartz), basalt fibers, aramid fibers, and combinations thereof. In some examples, the continuous fibers are arranged in planar portions of the structure and/or discontinuous fibers are arranged in non-planar or irregular portions of the structure.

In some examples, the EMI shielding layer 188 comprises a woven metal mesh, a continuous or discontinuous flexible fabric, a coated veil, a metal sheet, a perforated metal sheet, or a metal-coated fiber-filled material. For example only, the EMI shielding layer may comprise aluminum foil, copper mesh, nickel mesh, copper and nickel electrolytic coated carbon fiber.

In FIG. 2B, the reinforcing portion 164 is consolidated and then the thermal protecting portion 160 is attached using adhesive (and/or surface treatment) or consolidated in a second consolidation step. The shielding portion 168 is also attached using adhesive (and/or surface treatment) or consolidated in the second or subsequent consolidation step on the other side of the reinforcing portion 164.

For example, one or more layers 192 of the thermal protecting portion 160 are attached by an adhesive layer 193 to one side of the reinforcing portion 164. In some examples, the one or more layers 192 include a thermal insulating layer and/or a flamer barrier layer. In some examples, the reinforcing layer 164 includes reinforcing fibers 186. In some examples, the reinforcing fibers 186 include continuous fibers, discontinuous fibers, and/or a mixture of continuous and discontinuous fibers. The shielding layer 168 includes an electromagnetic interference (EMI) shielding layer 193 attached by adhesive 194 (and/or surface treatment) to the reinforcing portion 164.

In FIG. 2C, the thermal protecting portion 160 comprises a protective coating layer 196 that is coated onto an exposed surface of the reinforcing portion 164. In some examples, the protective coating layer 196 is applied in a liquid form using spray coating, dip coating, flow coating, and/or other suitable coating methods. In some examples, the coatings include fire retardant compounds, such as those described previously as fire retardants, intumescent materials, hydrated materials, and ceramics, as well as binders, solvents, and other additives used in coatings. In some examples, the protective coating layer 196 is cured using thermal, UV exposure, moisture, and/or chemical reactions at room temperature (or another temperature) when reactants are combined.

In some examples, the EMI shielding layer 188 comprises a coating layer 198 that is applied in a liquid form and optionally cured as described above. In some examples, the EMI shielding layer includes a coating including conductive particles (e.g., copper, aluminum, silver, nickel, gold, tin, or graphene). In other examples, the shielding layer is applied using a metal plating process.

In some examples, the hybrid composite structure is able to withstand a flame of 950° C. for 5 minutes while limiting temperature on the opposite side of the hybrid composite structure to a temperature less than 370° C.

In some examples, the hybrid composite structure includes discontinuous carbon fiber in a thermoplastic polymer matrix. In some examples, the discontinuous carbon fiber comprises unidirectional tape, nonwoven mat, and/or directed long fiber technologies used with compression molding or stamp forming. In some examples, the hybrid composite structure includes chopped carbon fiber fillers and a polymer matrix including a thermoplastic polymer selected from a group consisting of polyether ether ketone (PEEK), polyether ketone ketone (PEKK), polyphenylene sulfide (PPS), polyether imide (PEI), and combinations thereof.

In some examples, the hybrid composite structure includes continuous fibers in flat regions and discontinuous fibers in regions of non-planar geometric features, such as a channel, ribs, stiffener, and/or hat sections. In some examples, the hybrid composite structure is produced in a single consolidation step using a compression molding process.

Referring now to FIGS. 3 to 5, examples of methods 250, 300, and 400 for manufacturing the hybrid composite structure and/or enclosures incorporating the hybrid composite structure are shown. In FIG. 3, the method 250 includes arranging protection layer(s), reinforcing fibers, and shielding layer in a stack at 260. At 264, the stack is impregnated with resin (e.g., thermoplastic resin) and consolidated using pressure and/or heat into multi-layered and multi-function hybrid composite structure in a single step. At 268, an enclosure or other structure is manufactured using the multi-layered hybrid composite structure.

In FIG. 4, the method 300 includes arranging reinforcing fibers in a pattern at 310. At 314, the reinforcing fibers are impregnated with resin (e.g., thermoplastic resin) and consolidated using pressure and/or heat to form the reinforcing portion. At 318, the thermal/fire portion and the EMI shielding portion are attached to or consolidated on opposite sides of reinforcing portion to create multi-layered and multi-function hybrid composite structure. At 322, an enclosure or other structure is manufactured using the multi-layered hybrid composite structure.

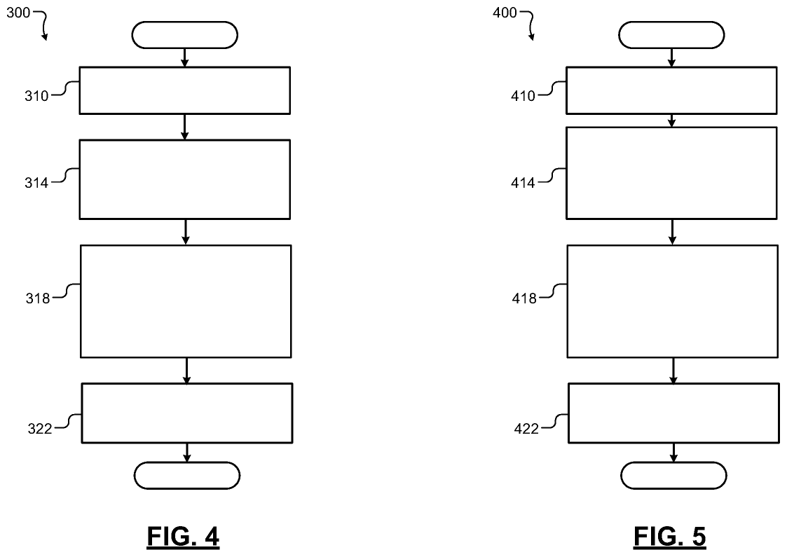

In FIG. 5, the method 400 includes arranging reinforcing fibers in a pattern at 410. At 414, the reinforcing resin and one of the thermal/fire portion or the shielding portion are impregnated with resin (e.g., thermoplastic resin) and consolidated using pressure and/or heat to form a consolidated core. At 418, the other one of the thermal/fire portion and the EMI shielding portion is attached or consolidated to the consolidated core to create multi-layered and multi-function hybrid composite structure. At 422, an enclosure or other structure is manufactured using the multi-layered hybrid composite structure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A multi-layer and multi-functional composite structure, comprising:
a structural reinforcing portion configured to provide structural support and including reinforcing fibers consolidated in a thermoplastic resin;
a protecting portion arranged on one side of the structural reinforcing portion and configured to provide at least one of thermal blocking and fire resistance; and
a shielding portion arranged on an opposite side of the structural reinforcing portion and configured to shield electromagnetic interference (EMI).

2. The multi-layer and multi-functional composite structure of claim 1, wherein the structural reinforcing portion and at least one of the protecting portion and the shielding portion are consolidated in the thermoplastic resin in a single step.

3. The multi-layer and multi-functional composite structure of claim 1, wherein the structural reinforcing portion, the protecting portion, and the shielding portion are consolidated in the thermoplastic resin in a single step.

4. The multi-layer and multi-functional composite structure of claim 1, wherein the protecting portion includes an intumescent material.

5. The multi-layer and multi-functional composite structure of claim 4, wherein the intumescent material includes an adhesive layer configured to attach the intumescent material to the structural reinforcing portion.

6. The multi-layer and multi-functional composite structure of claim 1, wherein the protecting portion includes a mica plate attached to the protecting portion using a binder.

7. The multi-layer and multi-functional composite structure of claim 1, wherein the protecting portion includes a fabric, a thermal material, and a fire resistant material.

8. The multi-layer and multi-functional composite structure of claim 1, wherein the protecting portion includes a ceramic layer.

9. The multi-layer and multi-functional composite structure of claim 1, wherein at least one of the protecting portion and the shielding portion comprises a coating.

10. The multi-layer and multi-functional composite structure of claim 1, wherein the shielding portion is selected from a group consisting of a metal mesh, a discontinuous fabric, a coated veil, a metal sheet, a perforated metal sheet, and a metal-coated fiber-filled material.

11. The multi-layer and multi-functional composite structure of claim 1, wherein the structural reinforcing portion comprises discontinuous fibers selected from a group consisting of chopped fibers, unidirectional tape, nonwoven mat, and directed long fibers.

12. The multi-layer and multi-functional composite structure of claim 1, wherein the thermoplastic resin is selected from a group consisting of polyether ether ketone, polyether ketone ketone, polyphenylene sulfide, and polyether imide.

13. The multi-layer and multi-functional composite structure of claim 1, wherein planar portions of the structural reinforcing portion comprise continuous fibers and non-planar portions of the structural reinforcing portion comprise discontinuous fibers.

14. A multi-layer and multi-functional composite structure, comprising:
a structural reinforcing portion configured to provide structural support and including reinforcing fibers consolidated in a thermoplastic resin;
a protecting portion arranged on one side of the structural reinforcing portion and configured to provide at least one of thermal blocking and fire resistance; and
a shielding portion arranged on an opposite side of the structural reinforcing portion and configured to shield electromagnetic interference (EMI),
wherein the structural reinforcing portion and at least one of the protecting portion and the shielding portion are consolidated in the thermoplastic resin in a single step.

15. The multi-layer and multi-functional composite structure of claim 14, wherein the structural reinforcing portion, the protecting portion, and the shielding portion are consolidated in the thermoplastic resin in a single step.

16. The multi-layer and multi-functional composite structure of claim 14, wherein the protecting portion is selected from a group consisting of an intumescent material one of consolidated in the thermoplastic resin and attached to the structural reinforcing portion, a mica plate attached to the protecting portion using a binder, a ceramic layer, and a coating layer.

17. The multi-layer and multi-functional composite structure of claim 14, wherein the protecting portion includes a fabric, a thermal material, and a fire resistant material.

18. The multi-layer and multi-functional composite structure of claim 14, wherein the shielding portion is selected from a group consisting of a metal mesh, a discontinuous fabric, a coated veil, a metal sheet, and a metal-coated fiber-filled material.

19. The multi-layer and multi-functional composite structure of claim 14, wherein:
the structural reinforcing portion comprises discontinuous fibers selected from a group consisting of chopped fibers, unidirectional tape, nonwoven mat, and directed long fibers, and
the thermoplastic resin is selected from a group consisting of polyether ether ketone, polyether ketone ketone, polyphenylene sulfide, and polyether imide.

20. The multi-layer and multi-functional composite structure of claim 14, wherein planar portions of the structural reinforcing portion comprise continuous fibers and non-planar portions of the structural reinforcing portion comprise discontinuous fibers.
